(19) United States
(12) Patent Application Publication
(10) Pub. No.: US 2021/0261013 A1
(43) Pub. Date: Aug. 26, 2021

(54) EXTERNAL POWER SUPPLY SYSTEM AND EXTERNAL POWER SUPPLY METHOD

(71) Applicant: HONDA MOTOR CO., LTD., Tokyo (JP)

(72) Inventor: Shuichi KAZUNO, Saitama (JP)

(21) Appl. No.: 17/180,874

(22) Filed: Feb. 22, 2021

(30) Foreign Application Priority Data
Feb. 25, 2020 (JP) 2020-029089

(51) Int. Cl. B60L 53/66; H02J 7/00; B60L 53/65; B60L 53/53; G05B 15/02

(52) U.S. Cl. CPC B60L 53/66; H02J 7/00045; G06Q 30/018; B60L 53/53; G05B 15/02; B60L 53/65

(57) ABSTRACT

Proposed is an external power supply system and an external power supply method which are highly convenient in a case in which an electric moving body is used in an external power supply application. An external power supply system 1 includes: an electric moving body 10 including power supply devices 111 and 112, a communication unit 12, and a first control unit 13; a mobile terminal 20 configured to communicate with the communication unit 12; and a server device 40 configured to communicate with the communication unit 12 and the mobile terminal 20, in which the mobile terminal 20 is configured to transmit authentication information to the communication unit 12 or the server device 40, so as to request power supplying of an supply target 50.

This application is based on and claims the benefit of priority from Japanese Patent Application No. 2020-029089, filed on 25 Feb. 2020, the content of which is incorporated herein by reference.

### BACKGROUND OF THE INVENTION

### Field of the Invention

The present invention relates to an external power supply system and an external power supply method.

### Related Art

Conventionally, a system has been known which charges for electricity in accordance with the amount of charged electric power, when charging a battery equipped to an electric moving body such as an electric vehicle.

Such a battery of an electric moving body is charged in ordinary homes or using charging equipment installed by various businesses.

For example, after the charging of a battery of an electric moving body, mutual authentication is performed between the charging server and the electric moving body in order to perform billing of electricity fees (refer to Japanese Unexamined Patent Application, Publication No. 2015-049851).
Patent Document 1: Japanese Unexamined Patent Application, Publication No. 2015-049851

### SUMMARY OF THE INVENTION

However, the power supply device such as a battery equipped to an electric moving body has sufficient electrical capacity that can be used, for example, as a power source for home or business use.

For this reason, there is a need to share and use such an electric moving body not only as a vehicle, but also as an external power supply in a community.

An optimum sharing method has not been proposed in the prior art for a case in which an electric moving body is used in an external power supply application. For example, there is a problem in that management is difficult with an operation method such as rental of a key of an electric moving body.

The present invention has been made in view of the above, and an object thereof is to propose an external power supply system and an external power supply method which are highly convenient in a case using an electric moving body in an external power supply application.

According to a first aspect, the present invention relates to an external power supply system including: an electric moving body including a power supply device, a communication unit, and a first control unit; a mobile terminal configured to communicate with the communication unit; and a server device configured to communicate with the communication unit and the mobile terminal, in which the mobile terminal is configured to transmit authentication information to the communication unit or the server device, so as to request power supplying of an supply target.

According to the first aspect of the invention, it is possible to provide an external power supply system that is highly convenient in a case in which an electric moving body is used in an external power supply application.

According to a second aspect, the external power supply system according to the first aspect further includes a power supply facility configured to receive electric power from the power supply device and supply power to the supply target, in which the power supply facility includes a converter and a second control unit, the first control unit or the second control unit transmits power supply information to the communication unit or the server device, when the power supply to the supply target ends, and at least either of the communication unit or the server device includes a storage unit configured to store the authentication information and the power supply information.

According to the second aspect of the invention, since it is possible to manage the power supply information in a case in which the electric moving body is used in an external power supply application, it is possible to further improve the convenience of the external power supply system.

According to a third aspect, in the external power supply system according to the second aspect, the power supply facility further includes at least one battery, in which the second control unit is configured to receive on-board information and battery control information, and power is supplied to the supply target via the battery.

According to the third aspect of the invention, when the external power supply is performed, since the external power supply is performed via the battery, when the external power supply is performed, there is no need for the electric moving body and the power supply facility to be electrically connected.

Furthermore, even when performing quick charging or the like to the supply target, it is possible to suppress the deterioration of the power supply device such as an on-board battery of the electric moving body.

According to a fourth aspect, in the external power supply system according to any one of the first aspect to the third aspect, when the authentication information is acquired, the first control unit or the server device performs comparison with user registration information registered in advance, and the first control unit transmits a power supply permitted signal to the power supply device based on a result of the comparison, and performs control to prohibit an operation of a traveling drive device of the electric moving body.

According to the fourth aspect of the invention, when the external power supply of the electric moving body is performed, since the operation of the traveling drive device is prohibited, it is possible to ensure the safety, and is possible to prevent unauthorized use of the electric moving body.

According to a fifth aspect, the present invention relates to an external power supply method including: a registration step including registering user information to a communication unit of an electric moving body or a server device; a power supply request step including transmitting authentication information from a mobile terminal to the communication unit or the server device; a comparison step including comparing the authentication information with user registration information; a power supply permission step including transmitting a power supply permitted signal to a power supply device of an electric moving body; a power supply step including supplying power to an supply target; and a power supply information transmission step including transmitting power supply information to the communication unit, when power supplying to the supply target ends.

According to the fifth aspect of the invention, it is possible to provide a highly convenient, external power supply method in a case in which the electric moving body is used in an external power supply application.

According to a sixth aspect, the external power supply method according to the fifth aspect further includes a traveling prohibition signal transmission step including transmitting a traveling prohibition signal to a traveling drive device of the electric moving body prior to or at the same time as the power supply permission step.

According to the sixth aspect of the invention, it is possible to ensure the safety in a case in which the external power supply is performed by the electric moving body, and is also possible to provide an external power supply method capable of preventing unauthorized use of the electric moving body.

### BRIEF DESCRIPTION OF THE DRAWINGS

FIG. 1 is a diagram showing a functional configuration of an external power supply system 1 according to a first embodiment;

FIG. 2 is a diagram showing a functional configuration of an external power supply system 1a according to a second embodiment; and

FIG. 3 is a flow diagram showing a flow of an external power supply method of the present embodiment.

### DETAILED DESCRIPTION OF THE INVENTION

Hereinafter, an external power supply system of the present invention and embodiments of the external power supply system will be described with reference to the drawings.

### First Embodiment

### (External Power Supply System)

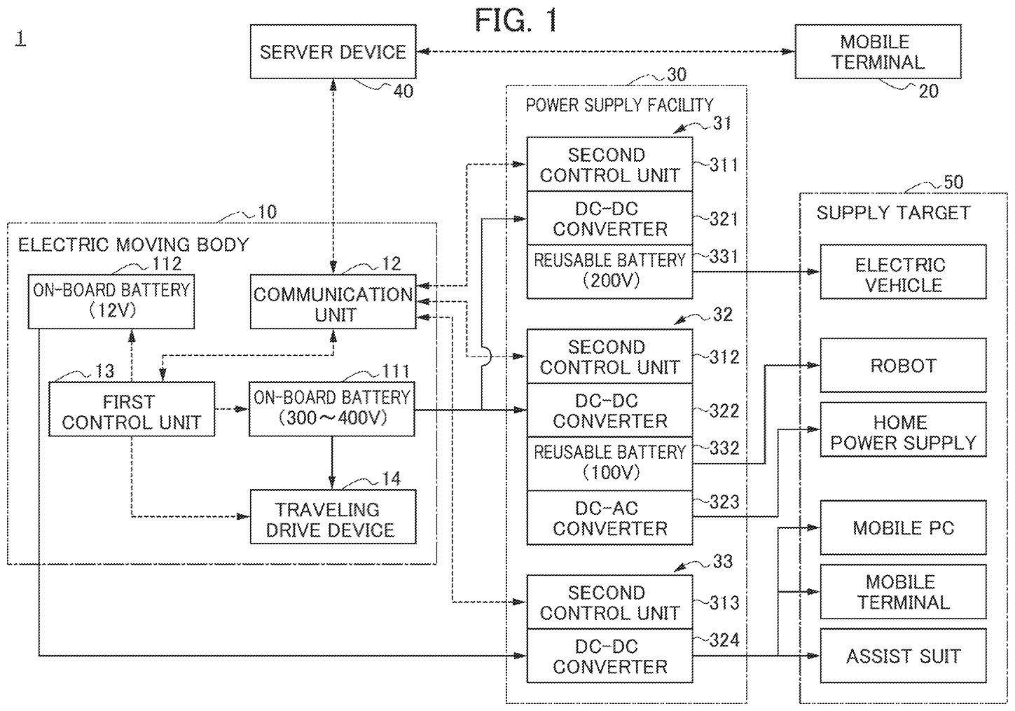

FIG. 1 is a diagram showing an example of a functional configuration of an external power supply system 1 of the present embodiment.

The external power supply system 1 includes an electric moving body 10, a mobile terminal 20, a power supply facility 30, and a server device 40.

The external power supply system 1 performs powering of a supply target 50.

In FIG. 1, solid line arrows indicate the flow of electricity, and broken line arrows indicate the flow of information.

The electric moving body 10 is, for example, an electric vehicle or a hybrid electric vehicle traveling by electric power.

The electric moving body 10 includes on-board batteries 111 and 112 as power supply devices, a communication unit 12, a first control unit 13, and a traveling drive device 14.

The electric moving body 10 is driven by electric power stored in the on-board batteries 111 and 112 being supplied to the traveling drive device 14, and then travels.

The on-board batteries 111 and 112 are each a secondary battery such as a lithium-ion battery capable of repeatedly charging and discharging.

The on-board battery 111 is a battery for traveling, and has a voltage of, for example, 300 V to 400 V.

The on-board battery 112 is a battery for accessories, and has a voltage of, for example, 12 V.

The on-board batteries 111 and 112 are capable of supplying power to the traveling drive device 14, and are also able to supply power to the supply target 50 via the power supply facility 30.

The power stored in the on-board battery 111 is stepped down by a converter, and supplied to the on-board battery 112.

The communication unit 12 is, for example, an on-board telematics communication unit (TCU), and is configured to be able to communicate with the first control unit 13, the mobile terminal 20, the server device 40, and the second control unit.

Registration information and authentication information of a user of the external power supply system 1 who wishes to supply power to the supply target 50 (hereinafter, sometimes simply referred to as “user”) are coordinated between the server device 40 and the first control unit 13 via the communication unit 12.

Similarly, the power supply information from the on-board batteries 111 and 112 to the power supply facility 30, the state of the on-board batteries 111 and 112, the state of the batteries 331 and 332, and the like are coordinated between the first control unit and the second control unit.

The first control unit 13 is, for example, an electronic control unit (ECU) for use in a vehicle, and includes a battery control ECU for controlling the on-board batteries 111 and 112, a motor ECU for controlling the traveling drive device 14, an engine ECU, and the like.

The first control unit 13 can communicate with the communication unit 12, the on-board batteries 111 and 112, the traveling drive device 14 and the like by CAN communication and the like.

The first control unit 13 may have a storage unit capable of storing the power supply information which is transmitted from the second control unit in addition to the above.

The storage unit includes a storage medium such as a hard disk or flash memory, for example.

The first control unit 13 transmits a power supply permitted signal to the on-board batteries 111 and 112 based on the authentication information or an authentication result received from the communication unit 12.

In addition to the above, the first control unit 13 may be capable of performing user registration based on the user registration information acquired from the communication unit 12, user verification when a power supply request is made from the user, and the like. Furthermore, the power supply information upon the power supply ending may be transmitted to the server device 40 via the communication unit 12.

The traveling drive unit 14 includes a traveling motor of the electric moving body 10.

The traveling drive device 14 is controlled by the motor ECU of the first control unit 13, so that the driving force applied to the traveling motor is controlled.

It should be noted that, in the case of the electric moving body 10 being a hybrid electric vehicle, the traveling drive device may include an engine.

In this case, the above engine is controlled by the engine ECU of the first control unit 13.

The mobile terminal 20 is, for example, a mobile terminal owned by the user.

The mobile terminal 20 can communicate with the server device 40 via a network such as the Internet.

Furthermore, the mobile terminal 20 may be capable of communicating with the communication unit 12 by short-range wireless communication or the like.

The user transmits the registration information to the server device 40 or the communication unit 12 through the mobile terminal 20, and performs user registration.

Thereafter, the user transmits authentication information to the server device 40 or the communication unit 12 via the mobile terminal 20 when requesting power supply to the supply target 50.

The mobile terminal 20 is not particularly limited, and a known mobile terminal such as a smartphone or a tablet computer can be used.

The power supply facility 30 receives power from the on-board batteries 111 and 112, and supplies power to the supply target 50.

The power supply facility 30 includes a second control unit, a converter.

The power supply facility 30 may include a battery in addition to the above.

In the present embodiment, the power supply facility 30 includes three power supply facilities 31, 32 and 33.

The power supply facility 31 includes a second control unit 311, a converter 321, and a battery 331.

Other than the elements mentioned above, the power supply facility 31 includes a charging cable in which a charging connector is provided at the tip and, for example, electric power can be supplied to an electric vehicle as the supply target 50.

The power supply facility 31 may be capable of quickly charging the electric vehicle.

The second control unit 311 can communicate with the communication unit 12 by, for example, short-range wireless communication or the like, and transmits and receives on-board information, converter control information, SOC (State of Charge) information, deterioration information of the on-board battery 111, or the like with the communication unit 12.

The second control unit 311 monitors the state of the battery 331 as described above, and cooperates with the first control unit 13.

For example, when detecting an abnormality such as in the current value or temperature of the battery 331 during power supply to the supply target 50, the second control unit 311 performs a fail determination, and performs control to stop the power supply.

In addition to the above, the second control unit 311 transmits the power supply information to the communication unit 12 when the power supplying ends.

The converter 321 is a DC-DC converter, and steps down the DC voltage received from the on-board battery 111 while DC.

The converter 321 steps down the power supplied from the on-board battery 111, and is supplied to the battery 331 and stored therein.

The battery 331 has a voltage of 200 V, for example, and stores electric power supplied from the on-board battery 111.

Since the power supply facility 31 has a battery 331, for example, when quickly charging the supply target 50 such as an electric vehicle, it is possible to quickly charge without excessive burden on the on-board battery 111.

The battery 331 is preferably a reusable battery which is, for example, a used battery such as an on-board battery for automotive use or the like to be reused.

This reduces the replacement cost of the battery 331 when the frequency of using the battery 331 for quick charging is high.

The power supply facility 32 has a battery 332 having a voltage of 100 V, for example, which is a voltage different from the battery 331 of the power supply facility 31.

The battery 332 can supply power to a robot such as, for example, a drone or a self-propelled robot as the supply target 50.

A converter 323 is connected to the battery 332.

The converter 323 is a DC-AC converter, which converts the DC voltage of the battery 332 to an AC voltage, and can supply power to, for example, a home power supply as the supply target 50.

The power supply facility 33 does not have a battery, but has a second control unit 313 and a converter 324 only.

The converter 324 is a DC-DC converter, and steps down the DC voltage received from the on-board battery 112 while DC.

The stepped-down electric power can be supplied to, for example, a mobile PC, a mobile terminal, an assist suit, or the like as the supply target 50.

It should be noted that the configuration of the power supply facilities 32 and 33 other than the above is the same as that of the power supply facility 31.

The server device 40 is configured as a distributed server consisting of one or more servers.

In addition to the above, the server device 40 may be configured as a distributed virtual server created in a cloud environment called a cloud server.

The server device 40 includes an arithmetic unit configured by a CPU, ROM, RAM or the like, and a storage unit such as a hard disk.

The server device 40 can communicate with the mobile terminal 20 and the communication unit 12 via a network such as the Internet.

The server device 40 performs user registration based on the user registration information transmitted from the mobile terminal 20, and transmits the authentication information to the mobile terminal 20. Upon receiving a power supply request from the user together with the authentication information via the mobile terminal 20, the server device 40 performs verification with the user registration information, and transmits the result of the verification to the communication unit 12.

In addition to the above, the server device 40 may store the authentication information and the power supply information transmitted via the communication unit 12 in the storage unit in association with each other.

Furthermore, it may be able to calculate a power supply cost to be billed to the user based on the power supply information.

The above user registration, verification, and storage may be performed by the first control unit 13.

The supply target 50 is a target for which the user requests power supply, and is not particularly limited as long as it is an object to which power can be supplied.

Since it is possible for the power supply facility 30 according to the present embodiment to supply power from a battery having a plurality of voltages, it is possible to supply power to the supply target 50 at various voltages according to the application.

### (External Power Supply Method)

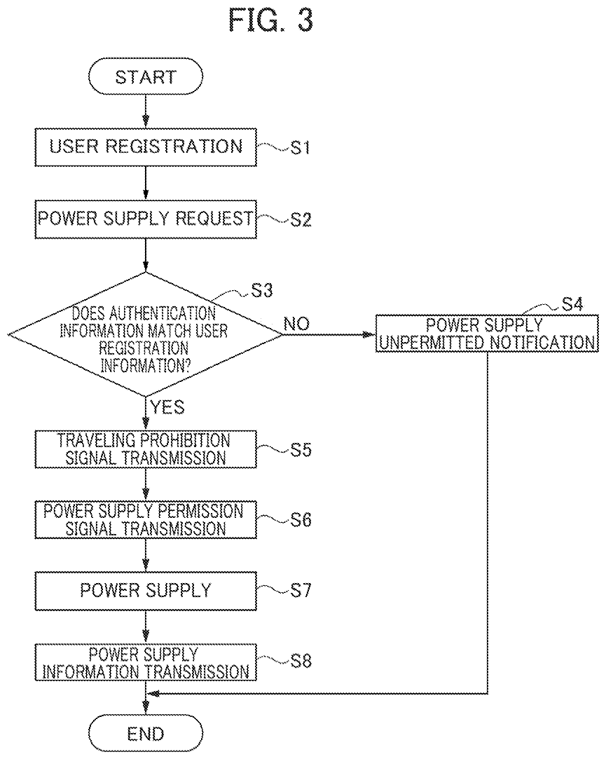

Next, an external power supply method performed using the external power supply system 1 according to the first embodiment will be described below with reference to a flow diagram shown in FIG. 3. As shown in FIG. 3, the external power supply method according to the present embodiment includes a registration step S1, a power supply request step S2, a verification step S3, a power supply unpermitted notification step S4, a traveling prohibited signal transmission step S5, a power supply permitted signal transmission step S6, a power supply step S7, and a power supply information transmission step SB.

In the registration step S1, a user who desires to use the external power supply system 1 transmits user registration information to the communication unit 12 or the server device 40 via the mobile terminal 20.

The first control unit 13 or the server device 40 outputs authentication information that can identify the user based on the received user registration information.

The authentication information is transmitted to the mobile terminal 20, and the user acquires the authentication information.

In the power supply request step S2, the user transmits the authentication information to the communication unit 12 or the server device 40 by the mobile terminal 20 to request power supplying to the supply target 50.

Information such as a desired power supply amount, power supply voltage, and the like may be transmitted to the supply target 50 together with the authentication information.

In the verification step S3, the first control unit 13 or the server device 40 performs verification between the stored user registration information and the received authentication information. In a case in which it is determined that the stored user registration information matches the authentication information, a result of the verification is outputted, and the processing advances to the traveling prohibited signal transmission step S5.

In a case in which it is determined that the user registration information and the authentication information do not match with each other, the result of the verification is outputted, and the processing advances to the power supply unpermitted notification step S4.

In the power supply unpermitted notification step S4, the first control unit 13 or the server device 40 performs the power supply unpermitted notification by sending a message or the like to the mobile terminal 20 based on the output result of the verification. After the power supply unpermitted notification is performed, the processing ends.

In the traveling prohibited signal transmission step S5, the first control unit 13 transmits a traveling prohibited signal to the traveling drive device 14 based on the result of the verification outputted by itself or received from the server device 40.

Thus, for example, the supply of power from the on-board battery Ill to the traveling drive device 14 is prohibited.

After the traveling prohibited signal transmission step S5, the processing advances to the power supply permitted signal transmission step S6.

It should be noted that the traveling prohibited signal transmission step S5 may be performed at the same time as the power supply permitted signal transmission step S6.

In the power supply permitted signal transmission step S6, the first control unit 13 transmits a power supply permitted signal to the on-board batteries 111 and 112 based on the result of the verification outputted by itself or received from the server device 40.

Thus, the power supply to the power supply facility 30 or the supply target 50 from the on-board batteries 111 and 112 is permitted.

After the power supply permitted signal transmission step S6, the processing advances to the power supply step S7.

In the power supply step S7, power is supplied directly from the on-board batteries 111 and 112 or through the power supply facility 30 to the supply target 50.

In the power supply step S7, the first control unit 13 and the second control units 311, 312, and 313 monitor current values, temperatures, and the like of the on-board batteries 111 and 112 and the batteries 331 and 332.

When an abnormality is detected in each battery, the first control unit and the second control unit perform fail determination in cooperation via the communication unit 12, and perform control to stop the power supply.

Other than the above, the second control units 311, 312 and 313 monitor the SOC and the degradation state of the on-board batteries 11 and 112, and in a case in which it is determined that the battery replacement is necessary, replacement request information may be transmitted to the communication unit 12.

After the power supplying in the power supply step S7 is completed, the processing advances to the power supply information transmission step S8.

In the power supply information transmission step S8, when the power supplying to the supply target 50 is completed, the second control units 311, 312 and 313 transmit the power supply information such as the amount of power supplied and the power supply time to the communication unit 12.

The transmitted power supply information is stored in the first control unit 13 or the storage unit of the server device 40 in association with the authentication information.

In addition to the above, the power supply information may be transmitted to the server device 40 by the first control unit 13 and may be stored in the storage unit of the server device 40.

Based on the power supply information, the power supply cost to be billed to the user may be calculated, and information such as the power supply cost may be transmitted to the mobile terminal 20.

After the power supply information transmission step S8 is performed, the processing ends.

### Second Embodiment

### (External Power Supply System)

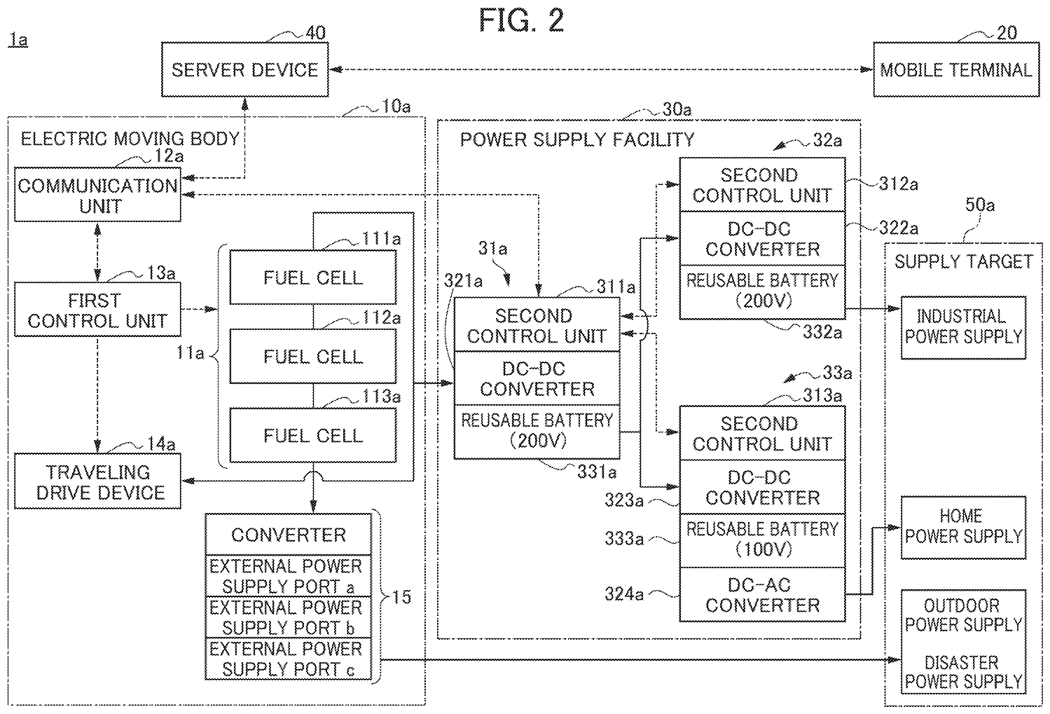

Next, with reference to FIG. 2, the configuration of an external power supply system 1a according to a second embodiment of the present invention will be described.

In the following description, explanations of portions shared with those of the first embodiment may be omitted.

The external power supply system 1a includes an electric moving body 10a, a mobile terminal 20, a power supply facility 30a, and a server device 40.

The electric moving body 10a is a fuel cell vehicle provided with a fuel cell 11a as a power supply device.

The electric moving body 10a includes a traveling drive device 14 which operates with the power generated by the fuel cell as a power source.

The electric moving body 10a includes a communication unit 12a, the first control unit 13a, and an external power supply unit 15 in addition to the above.

The fuel cell 11a includes a plurality of fuel cells 111a, 112a, and 113a, each of which has a voltage of about 200 V, for example.

The plurality of fuel cells are connected in parallel.

The plurality of fuel cells generate electric power by an electrochemical reaction between a fuel gas such as hydrogen gas and an oxidant gas such as air.

The generated power can be supplied to the traveling drive device 14a and the external power supply unit 15, and can also be supplied to the supply target 50a via the power supply facility 30a.

The external power supply unit 15 includes a DC-DC converter or a DC-AC converter, and a plurality of external power supply ports a, b, and c.

The external power supply unit 15 can supply the electric power generated by the fuel cell 11a, without passing through the power supply facility 30a, to the outdoor power supply, the disaster power supply or the like as the supply target 50a.

Thus, since the power supplying to the supply target 50a is possible even in a location where the power supply facility 30a is not installed, it is possible to expand the application of the external power supply system 1a.

The power supply facility 30a receives power generated by the fuel cell 11a, and supplies the power to the supply target 50a.

In the present embodiment, the power supply facility 30a includes a plurality of power supply facilities 31a, 32a, and 33a.

The power supply facility 31a includes a second control unit 311a, a DC-DC converter, and a battery 331a.

The power supply facility 31a directly receives the electric power generated by the fuel cell 11a, and supplies the electric power to the power supply facilities 32a and 33a via the battery 331a.

The power supply facility 31a does not perform power supply to the supply target 50a directly, but rather supplies power to the supply target 50a via the power supply facilities 32a and 33a.

As a result, when a load variation occurs in the supply target 50a, the battery 331a can be used for load variation absorption.

Therefore, it is possible to preferably perform power supply to the supply target 50a such as an industrial power source and a household power source in which load variation occurs.

While preferred embodiments of the present invention have been described above, the present invention is not intended to be limited to the above embodiments, and modifications can be appropriately made without departing from the object of the present invention.

In the above embodiment, an electric vehicle, a hybrid electric vehicle and a fuel cell vehicle have been described as examples for an electric moving body; however, the present invention is not limited to the above.

The system is not limited so long as the electric moving body can supply power to the outside.

For example, it may be an electric moving body having a system for supplying power to the outside by a plug-in hybrid vehicle or a gasoline engine.

### EXPLANATION OF REFERENCE NUMERALS

1 external power supply system
10 electric moving body
111, 112 power supply device
12 communication unit
13 first control unit
14 traveling drive device
20 mobile terminal
30 power supply facility
311 second control unit
321 converter
331 battery
40 server device
50 supply target

What is claimed is:

1. An external power supply system comprising:
an electric moving body including a power supply device, a communication unit, and a first control unit;
a mobile terminal configured to communicate with the communication unit; and
a server device configured to communicate with the communication unit and the mobile terminal,
wherein the mobile terminal is configured to transmit authentication information to the communication unit or the server device, so as to request power supplying of an supply target.

2. The external power supply system according to claim 1, further comprising a power supply facility configured to receive electric power from the power supply device and supply power to the supply target,
wherein the power supply facility includes a converter and a second control unit,
the first control unit or the second control unit transmits power supply information to the communication unit or the server device,
when the power supply to the supply target ends, and
at least either of the communication unit or the server device includes a storage unit configured to store the authentication information and the power supply information.

3. The external power supply system according to claim 2, wherein the power supply facility further includes at least one battery,
wherein the second control unit is configured to receive on-board information and battery control information, and
power is supplied to the supply target via the battery.

4. The external power supply system according to claim 1, wherein,
when the authentication information is acquired, the first control unit or the server device performs comparison with user registration information registered in advance, and
the first control unit transmits a power supply permitted signal to the power supply device based on a result of the comparison, and
performs control to prohibit an operation of a traveling drive device of the electric moving body.

5. An external power supply method comprising:
a registration step including registering user information to a communication unit of an electric moving body or a server device;
a power supply request step including transmitting authentication information from a mobile terminal to the communication unit or the server device;
a comparison step including comparing the authentication information with user registration information;
a power supply permission step including transmitting a power supply permitted signal to a power supply device of an electric moving body;
a power supply step including supplying power to an supply target; and
a power supply information transmission step including transmitting power supply information to the communication unit, when power supplying to the supply target ends.

6. The external power supply method according to claim 5, further comprising a traveling prohibition signal transmission step including transmitting a traveling prohibition signal to a traveling drive device of the electric moving body prior to or at the same time as the power supply permission step.
